(19) United States
(12) Patent Application Publication
(10) Pub. No.: US 2025/0303312 A1
(43) Pub. Date: Oct. 2, 2025

(54) INTERACTION APPARATUS

(71) Applicant: Sony Interactive Entertainment Inc., Tokyo (JP)

(72) Inventors: Toshiyuki ANDO, Tokyo (JP); Takuya KUJI, Tokyo (JP); Yumi UEDA, Tokyo (JP); Hitoshi NAKAMURA, Tokyo (JP)

(73) Assignee: Sony Interactive Entertainment Inc., Tokyo (JP)

(21) Appl. No.: 18/864,500

(22) PCT Filed: May 2, 2023
(86) PCT No.: PCT/JP2023/017156

§ 371 Date: Nov. 8, 2024

(30) Foreign Application Priority Data
May 13, 2022 (JP) 2022-079840

(51) Int. Cl. A63H 9/00; G06F 3/044

(52) U.S. Cl. CPC A63H 9/00; G06F 3/044; A63H 2200/00; G06F 2203/04105

(57) ABSTRACT

Provided is an interaction apparatus 1 including an outer shell 110 including a material having elasticity and at least one capacitance sensor 12 disposed near a surface of the outer shell 110. The capacitance sensor 12 includes a substrate section having elasticity and at least one sensor electrode disposed on the substrate section.

### TECHNICAL FIELD

The present invention relates to an interaction apparatus.

### BACKGROUND ART

In the related art, interaction apparatuses used to control information processing apparatuses such as home game machines are typically including such a material as plastic which is relatively less elastically deformable.

However, in recent years, various kinds of interaction apparatuses have been proposed in order to enrich user experience in games and the like.

### SUMMARY

### Technical Problem

For example, as interaction apparatuses, apparatuses like stuffed toys that include an outer cover such as fur are conceivable. However, upon touching tips of the fur of such an interaction apparatus, a user feels that the user is touching the interaction apparatus, but, when a touch sensor of the interaction apparatus is disposed at a relatively deep position inside the interaction apparatus, a touch as faint as a touch with the tips of the fur may fail to be detected.

The present invention has been made in view of the circumstances described above, and an object of the present invention is to provide an interaction apparatus that can increase the degree of freedom for the outer cover.

### Solution to Problem

An aspect of the present invention provides an interaction apparatus including an outer shell including a material having elasticity and at least one capacitance sensor disposed near a surface of the outer shell. The capacitance sensor includes a substrate section having elasticity and at least one sensor electrode disposed on the substrate section.

### Advantageous Effect of Invention

The present invention can increase the degree of freedom for the outer cover of the interaction apparatus.

### BRIEF DESCRIPTION OF DRAWINGS

FIG. 1 is a schematic explanatory diagram representing a general configuration of an interaction apparatus 1 according to an embodiment of the present invention.

FIG. 2 depicts a schematic cross-sectional view and a schematic perspective view that represent an example of a capacitance sensor included in the interaction apparatus 1 according to the embodiment of the present invention.

FIG. 3 is a schematic plan view representing an example of the capacitance sensor included in the interaction apparatus 1 according to the embodiment of the present invention.

FIG. 4 is a configuration block diagram representing an example of a circuit section included in the interaction apparatus 1 according to the embodiment of the present invention.

FIG. 5 is a flowchart diagram representing an example of operations of the interaction apparatus 1 according to the embodiment of the present invention.

FIG. 6 is an explanatory diagram representing an example of temporal variation in information delivered by the interaction apparatus 1 according to the embodiment of the present invention.

### DESCRIPTION OF EMBODIMENT

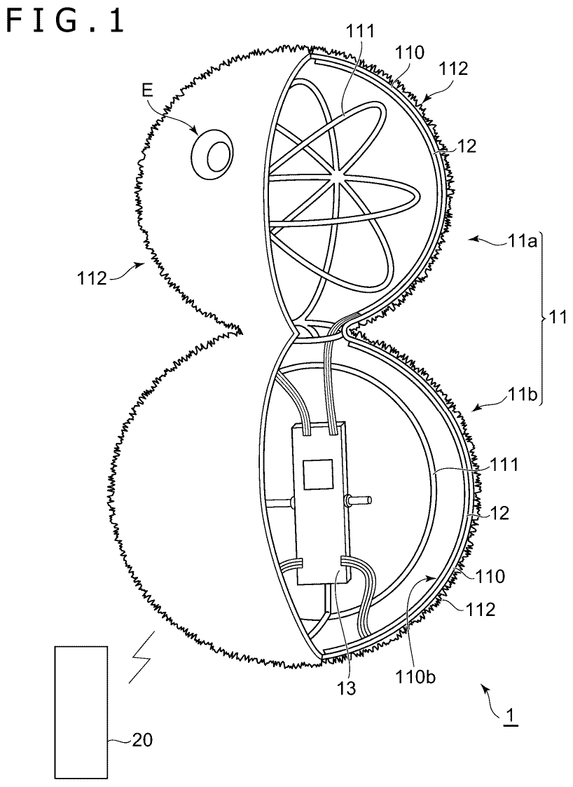

An embodiment of the present invention will be described with reference to the drawings. An interaction apparatus 1 according to the embodiment of the present invention includes an apparatus main body 11, a capacitance sensor 12, and a circuit section 13, and is communicably connected to an information processing apparatus 20 wirelessly or by wire, as illustrated in FIG. 1. FIG. 1 is a schematic perspective view illustrating an overview of the interaction apparatus 1 according to the embodiment of the present invention. In FIG. 1, the interaction apparatus 1 is partially broken to illustrate a cross section of the interaction apparatus 1.

Note that, in the description of the present embodiment below, the shape and size, the ratio among the sections, and the like of the interaction apparatus 1 are illustrative, and other shapes and sizes, the ratio among the sizes of the sections, and the like may differ from those illustrated.

Here, the apparatus main body 11 includes an outer shell 110 including a deformable material, for example, elastically deformable material. In addition, in the present embodiment, the apparatus main body 11 further includes a framework 111 disposed inside the outer shell 110.

A material for the outer shell 110 is only required to have elasticity as described above. As a material for the outer shell 110, an elastically deformable material such as a polymer gel material, as exemplified by a silicon-based polymer gel material or a urethane-based gel material, or any of various elastomer materials, as exemplified by a polystyrene-based elastomer, an olefin-based elastomer, a polyvinyl chloride elastomer, a polyurethane-based elastomer, a polyester-based elastomer, and a polyamide-based elastomer, is used, for example. In addition, the framework 111 preferably includes a material that is relatively unlikely to be elastically deformed compared to the outer shell 110. As a material for the framework 111, a resin material such as acrylonitrile-butadiene-styrene (ABS) resin or polylactic acid (PLA) resin, for example, may be used.

In the example in FIG. 1, the apparatus main body 11 has a shape in which a head 11a and a torso 11b are coupled together. In the example in FIG. 1, both the head 11a and the torso 11b are substantially spherical. In this example, the outer shell 110 is shaped to correspond to the head 11a and the torso 11b coupled together.

Further, in an example of the present embodiment, an outer cover 112 including fabric is disposed on an outer portion of a surface of the outer shell 110. The outer cover 112 is such fabric as fur, pile fabric, fake fur, or boa and is mounted on the outer portion of the surface of the outer shell 110. The outer cover 112 may be stuck to the outer shell 110 or may be removably mounted on the outer shell 110.

When subjected to no external force, the outer shell 110 of the apparatus main body 11 may have a predetermined shape such as a spherical shape or a rectangular shape, for example. In addition, the outer shell 110 is assumed to have the shape thereof elastically changed according to an external force when a user applies the external force to the outer shell 110 with his/her finger or the like.

The capacitance sensor 12 is assumed to be disposed near the outer shell 110 and at least on an outer side of the framework 111. In the present embodiment, the capacitance sensor 12 is stuck to and disposed on an inner side 110b (at least a part of an inner circumference of the outer shell 110) of the surface of the outer shell 110 as illustrated in FIG. 1. Yet, this is an example, and the capacitance sensor 12 may be disposed on an outer side of the surface of the outer shell 110 and between the outer shell 110 and the outer cover 112. As described above, when a sensor such as the capacitance sensor 12 is disposed on the inner side of the outer cover, the user does not feel the texture of the sensor, and operation performed by the user can be detected without impairing the texture of the outer cover 110 of the interaction apparatus.

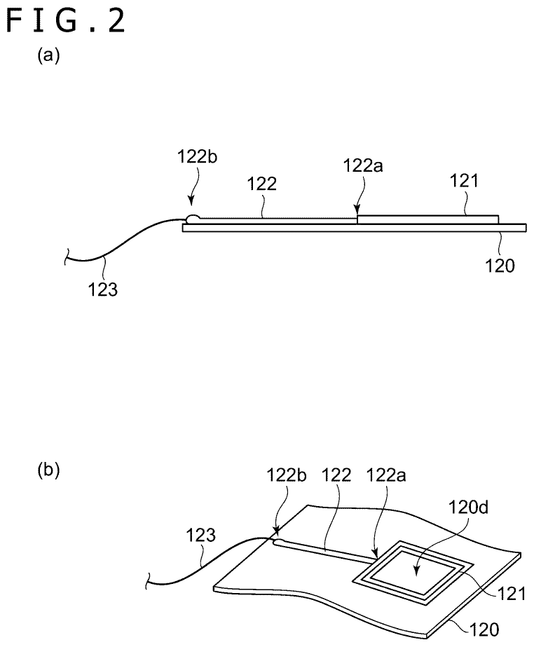

The capacitance sensor 12 includes a substrate section 120, electrodes 121, a lead section 122, and a wiring section 123, as illustrated in FIG. 2 including a cross section (FIG. 2(a)) and a perspective view (FIG. 2(b)) of the capacitance sensor 12. Here, the substrate section 120 is a thin-film-like member formed using an insulating material having elasticity (insulating polyimide, liquid crystal polymer, or the like).

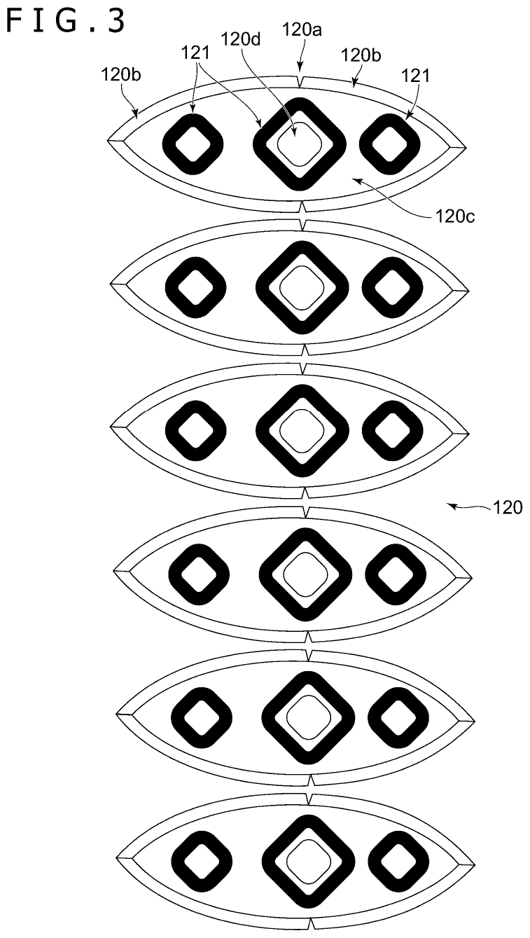

In an example of the present embodiment, as illustrated in FIG. 3 depicting an example of a plan view of the substrate section 120, the substrate section 120 is formed as a member having a development-diagram-like shape obtained by developing a three-dimensional shape that can be stuck to the outer shell 110 along the inner circumference of the outer shell 110. The substrate section 120 may include at least one cutout portion or may include at least one opening. The substrate section 120 may include both the cutout portion and the opening or may include one of the cutout portion and the opening. As illustrated in FIG. 3, the substrate section 120 includes, for example, a cutout portion 120a, a portion (referred to as an overlap space portion) 120b that is adjacent to the cutout portion 120a and that is disposed in such a manner as to overlap another portion when the substrate section 120 is formed into a three-dimensional shape, and a portion (main body) 120c stuck to the inner circumference of the outer shell 110. Note that an opening 120d may be formed in a part of the main body 120c. The opening 120d may have any shape depending on the shape of the outer shell 110, and may have, for example, a circular shape or a rectangular shape. As described above, in an example of the present embodiment, the capacitance sensor 12 is provided with at least one opening or cutout. Note that, in FIG. 3, illustration of the lead section 122 and the wiring section 123 is omitted.

The opening and the like facilitate arrangement of the capacitance sensor 12 along the inner surface of the outer shell 110 forming a three-dimensional shape. Further, the opening and the like improve flexibility of the capacitance sensor 12, and facilitate deformation corresponding to elastic deformation of the outer cover 110, compared to a case where the opening and the like are not provided.

In a case where the opening 120d is formed, the electrodes 121 and the lead section 122 are formed on the main body 120c of the substrate section 120 in such a manner as to avoid the opening 120d. In an example of the present embodiment, as illustrated in FIG. 3, the electrodes 121 are formed by disposing a conductive material at a plurality of positions in a part of the main body 120c of the substrate section 120. The conductive material may also have elasticity, and in that case, for example, a conductive ink material or the like is used. In the present embodiment, as illustrated in FIG. 3, the electrodes 121 are formed by disposing the conductive material within the range of a predetermined shape, with the opening (a portion with no conductive material disposed therein) formed in a part of the range.

In an example of the present embodiment, for example, the substrate section 120 illustrated in FIG. 3 is disposed in a hemisphere of the head 11a. In this example, approximately 18 electrodes 121 per hemisphere of the head 11a are assumed to be disposed in such a manner as to avoid overlapping one another.

The lead section 122 includes an end 122a electrically connected to each electrode 121, and is formed on the main body 120c of the substrate section 120 like a line with a predetermined width with use of a conductive material having elasticity. As is the case with the electrode 121, for example, a conductive ink material or the like can be used as a conductive material for forming the lead section 122.

The wiring section 123 is provided corresponding to the lead section 122 disposed corresponding to each electrode 121. The wiring section 123 is electrically connected at one end thereof to an end 122b of the corresponding lead section 122, the end 122b being opposite to an end 122a of the lead section 122, the end 122a being connected to the electrode 121, with the other end of the wiring section 123 connected to the circuit section 13. The wiring section 123 is disposed in such a manner as to avoid electrical contact with the wiring sections 123 corresponding to the other lead sections 122 disposed on the same substrate section 120 and with the other wiring sections 123 drawn from the other capacitance sensors 12.

Note that the capacitance sensor 12 in this example may employ a self capacitance method or a mutual capacitance method. In addition, here, the substrate section 120 desirably has a Young's modulus less than or equal to that of the outer shell 110 of the apparatus main body 11 (in other words, the substrate section 120 of the capacitance sensor 12 more easily expands and contracts than the outer shell 110). Further, the electrode 121 and the lead section 122 suitably have a Young's modulus less than or equal to that of the substrate section 120.

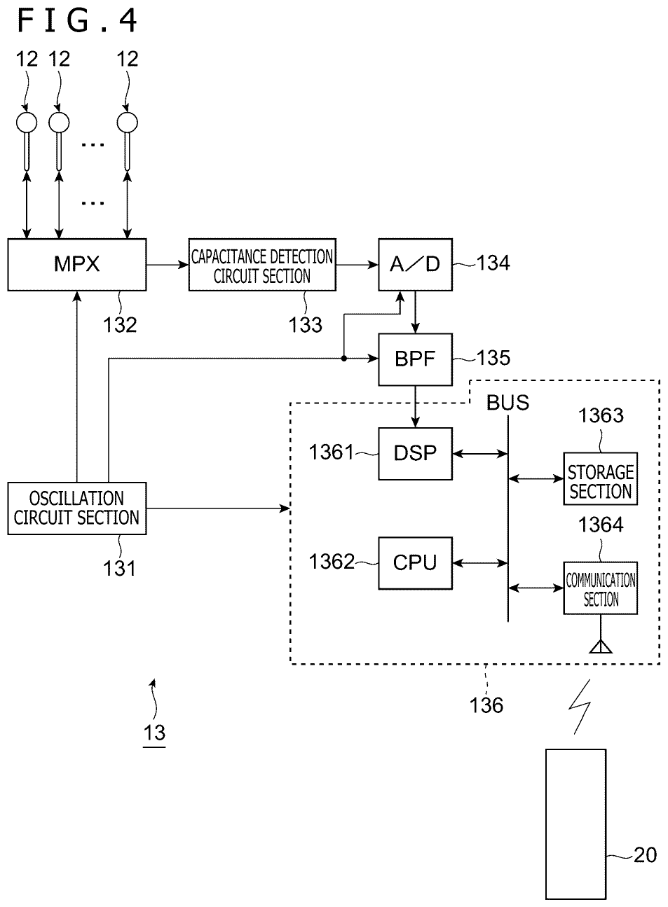

The circuit section 13 is disposed in a central portion of the apparatus main body 11 of the interaction apparatus 1 (at a position as far from the surface as possible). Specifically, the circuit section 13 is disposed inside the framework 111. For example, as illustrated in FIG. 4, the circuit section 13 includes an oscillation circuit section 131, an analog multiplexer (MPX) 132, a capacitance detection circuit section 133, an analog-to-digital (A/D) conversion section 134, a band-pass filter (BPF) section 135, and a control section 136. In addition, the control section 136 includes a digital signal processor (DSP) 1361, a central processing unit (CPU) 1362, a storage section 1363, and a communication section 1364. The DSP 1361, the CPU 1362, the storage section 1363, and the communication section 1364 are connected to each other via a bus BUS. Further, in an example of the present embodiment, the circuit section 13 includes an external-force sensor 137 and is connected to the control section 136.

Here, the oscillation circuit section 131 is an oscillation circuit that oscillates a sine wave with a predetermined frequency f and outputs an oscillated sine-wave signal to the analog multiplexer 132, the A/D conversion section 134, the BPF section 135, and the control section 136.

When a plurality of the electrodes 121 of the capacitance sensor 12 are disposed on the surface of the apparatus main body 11, the analog multiplexer 132 switchably sequentially selects one of the plurality of electrodes 121 at each predetermined timing (a predetermined period T>>t sufficiently greater than a period t of the sine-wave signal). The analog multiplexer 132 outputs, to the selected electrode 121, a sine-wave signal output by the oscillation circuit section 131.

The capacitance detection circuit section 133, for example, includes an LC resonance circuit, and outputs a resonance signal that is resonant with the sine-wave signal output to the electrode 121 of the capacitance sensor 12 selected by the analog multiplexer 132. The frequency f′ of this signal varies with the distance from the electrode 121 of the capacitance sensor 12 selected by the analog multiplexer 132 to the finger or hand of the user, the strength of push-in by the finger or hand of the user detected by the electrode 121, and the touch area of the electrode 121 touched by the finger of the user (via the outer shell 110.)

The A/D conversion section 134 converts a signal with the frequency f′ output by the capacitance detection circuit section 133 into a digital signal and outputs the digital signal. The BPF section 135 is a digital band-pass filter, and extracts a signal with a predetermined component near a predetermined frequency f0 from digital signals (representing signals with a frequency f′) output by the A/D conversion section 134.

The DSP 1361 of the control section 136 executes predetermined digital signal processing on the signal output by the BPF section 135 and outputs the processed signal to the CPU 1362. The CPU 1362 operates in accordance with a program stored in the storage section 1363, and determines a difference d between the signal output by the DSP 1361 and the signal with the frequency f output by the oscillation circuit section 131. In addition, the CPU 1362 calculates a difference Δ between the difference d and a preset output reference value B (initially set to “0,” for example), and outputs the difference Δ as information regarding an output value related to the electrode 121 of the capacitance sensor 12 (referred to as proximity touch information). The proximity touch information is used, for example, by the information processing apparatus 20 to estimate the distance between the corresponding electrode 121 and the finger or hand of the user or to estimate the pressing force applied to the electrode 121 by the finger or hand of the user.

The storage section 1363 holds the program to be executed by the CPU 1362. The program may be stored in a computer-readable and non-transitory storage medium for provision and copied to the storage section 1363 for storage. In addition, the storage section 1363 also operates as a work memory for the CPU 1362.

The communication section 1364 is a wireless local area network (LAN) interface or a wireless communication interface such as Bluetooth (registered trademark), for example, and delivers information to the information processing apparatus 20 in accordance with an indication received from the CPU 1362. In addition, the communication section 1364 outputs, to the CPU 1362, information received from the information processing apparatus 20.

In an example of the present embodiment, the CPU 1362 of the interaction apparatus 1 detects the capacitance of each of the electrodes 121 of the capacitance sensor 12 sequentially selected by the analog multiplexer 132, and outputs (delivers), to the information processing apparatus 20, proximity touch information obtained by estimating the distance to the finger or hand of the user or the pressing force applied to the electrode 121 by the finger or hand of the user.

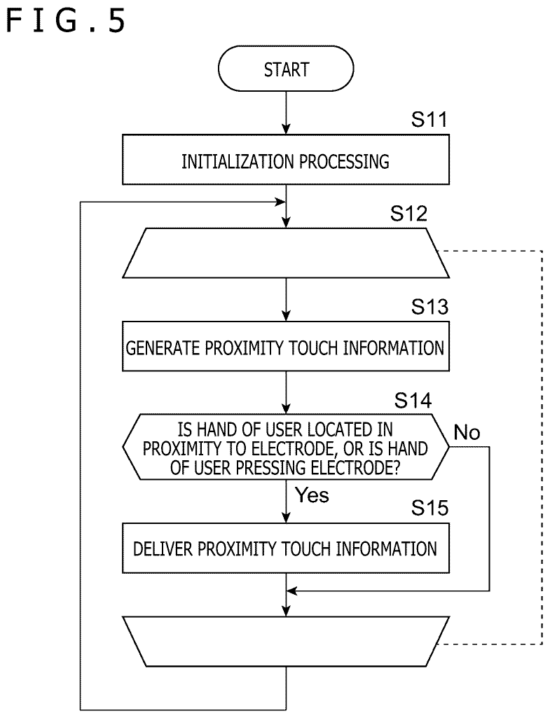

For example, as illustrated in FIG. 5, the CPU 1362 executes initialization processing such as setting of an output reference value at a predetermined timing such as power-on (S11), and executes next processing while sequentially selecting each electrode 121 of each capacitance sensor 12 (in other words, for each of the electrodes 121 built in the interaction apparatus 1) (S12).

The CPU 1362 generates proximity touch information for the electrode 121 by estimating the distance from the selected electrode 121 to the finger or hand of the user or the pressing force applied to the electrode 121 by the finger or hand of the user (S13).

The CPU 1362 determines whether or not the finger or hand of the user is determined to be in proximity to the selected electrode 121 and whether or not the selected electrode 121 has been pressed by the user, on the basis of the proximity touch information generated in step S13 (for example, whether or not a value indicative of the proximity touch information is below a predetermined threshold for determining that the hand of the user is not in proximity) (S14), and in a case where the finger or hand of the user is determined to be in proximity or in a case where the selected electrode 121 has been pressed by the user (S14: Yes), delivers, to the information processing apparatus 20, the generated proximity touch information and information (electrode identification information) for identifying the selected electrode 121 (S15). Here, electrode identification information may be an identifier defined in advance for each electrode 121.

In addition, in step S14, in a case where the finger or the like of the user is not determined to be in proximity and the electrode 121 has not been pressed by the user (S14: No), the CPU 1362 does not execute the processing in step S15.

Then, the CPU 1362 selects the next electrode 121 and repeats the processing from steps S13 to S15. In addition, upon executing the processing from steps S13 to S15 for all the electrodes 121, the CPU 1362 returns to the processing in step S12, and executes again the processing from steps S13 to S15 for each electrode 121 of each capacitance sensor 12.

In addition, the CPU 1362 receives, from the external-force sensor 137, input of a signal indicative of an external force exerted on the interaction apparatus 1. Then, the CPU 1362 delivers, to the information processing apparatus 20, the signal indicative of the external force. In addition, the CPU 1362 may execute predetermined external-force response processing based on the signal indicative of the external force. The contents of the predetermined external-force response processing will be described below.

The external-force sensor 137 includes an acceleration sensor, a potentiometer, or the like, and detects, for the interaction apparatus 1, an external force applied to the interaction apparatus 1 by the user. Here, the external force is assumed to be, for example, a force that moves or rotates the interaction apparatus 1, for example, and that is detected while the user is in touch with the interaction apparatus 1.

In an example of the present embodiment, when predefined time has elapsed from the last reception, from the external-force sensor 137, of input of a signal indicative of an external force exceeding a predetermined threshold, the CPU 1362 may determine that the interaction apparatus 1 is in a state in which the user is not in touch with the interaction apparatus 1 and execute processing for transitioning the interaction apparatus 1 to a power saving mode (mode in which power supply to each section is stopped, for example) as external-force response processing.

The information processing apparatus 20 is, for example, a home game machine, a personal computer, or any other computer device, and is communicably connected to the interaction apparatus 1. In the present embodiment, the information processing apparatus 20 obtains proximity touch information that is received from the interaction apparatus 1 and that indicates the distance between the finger or hand of the user and each of the electrodes 121 of the capacitance sensor 12 disposed on the inner surface of the outer shell 110 of the interaction apparatus 1 or the pressing force applied to the electrode 121 by the finger or hand of the user.

The information processing apparatus 20 estimates the operation performed by the user on the apparatus main body 11, on the basis of the proximity touch information related to each capacitance sensor 12.

### Operation

The interaction apparatus 1 of the present embodiment includes the configuration described above and operates as described below. In the following example, the apparatus main body 11 is assumed to have a shape in which the substantially spherical head 11a and the substantially spherical torso 11b are coupled together as illustrated in FIG. 1. In other words, the outer shell 110 is assumed to be shaped to correspond to the head 11a and the torso 11b coupled together. In addition, the outer cover 112 using fake fur fabric or the like is assumed to be mounted on the outer side of the outer shell 110.

In addition, members, such as eye buttons E, which constitute a feature such as the face, a hand, or a foot may further be disposed on the outer side of the outer shell 110.

With the interaction apparatus 1 placed on a desk or the like, the user performs, on the interaction apparatus 1, operations such as:
an operation of bringing the hand closer to the outer cover 112,
an operation of touching the outer cover 112,
an operation of stroking the surface of the outer cover 112,
an operation of pressing the outer shell 110 of the apparatus main body 11 via the outer cover 112,
an operation of pressing the outer shell 110 of the apparatus main body 11 via the outer cover 112 to deform the outer shell 110,
an operation of tapping the surface of the outer cover 112, and
an operation of releasing the hand touching or pressing the surface of the outer cover 112. In addition, the user may perform an operation of lifting and moving the interaction apparatus 1.

For example, when the user performs the operation of bringing the hand closer to the surface of the outer cover 112, the hand of the user approaches, among the capacitance sensors 12 disposed immediately below the outer shell 110, the electrode 121 located at a position relatively close to the position of the hand brought closer to the surface. Thus, the capacitance of the electrode 121 changes. Then, the CPU 1362 of the circuit section 13 detects the change to generate proximity touch information related to the electrode 121, and the generated proximity touch information is delivered to the information processing apparatus 20 along with the electrode identification information for the electrode 121.

In such a manner, for example, in a case where the outer cover 112 is fur or the like, by detecting the operation of bringing the hand closer to the outer cover 112 to the degree that the user barely touches the tips of the fur and utilizing a detection result, for example, sensitive body sensation of an animal such as a dog or a cat can be reproduced.

In addition, when the user performs the operation of stroking the surface of the outer cover 112, for example, the hand of the user approaches, among the capacitance sensors 12 disposed immediately below the outer shell 110, the electrode 121 located at a position relatively close to the position of the hand stroking the surface. Thus, the capacitance of the electrode 121 changes. Then, the CPU 1362 of the circuit section 13 detects the change to generate proximity touch information related to the electrode 121, and the generated proximity touch information is delivered to the information processing apparatus 20 along with the electrode identification information regarding the electrode 121.

In the present embodiment, when the user touches the surface of the outer cover 112 with the hand, among the electrodes 121 of the capacitance sensor 12 disposed immediately below the outer shell 110, the electrode 121 located in proximity to the hand of the user detects that the hand of the user is positioned in proximity.

Note that, in an example of the present embodiment, the substrate section 120 illustrated in FIG. 3 is disposed per hemisphere of the head 11a and thus approximately a dozen of electrodes 121 (in the example in FIG. 3, 18 electrodes 121) per hemisphere of the head 11a are disposed in such a manner as to avoid overlapping one another. In this case, when the user performs the above-described stroking operation, the hand of the user moves back and forth among the plurality of different electrodes 121, and thus, the CPU 1362 of the circuit section 13 detects the fingers of the user alternately approaching the plurality of electrodes 121. Therefore, the proximity touch information related to the plurality of electrodes 121 is alternately delivered to the information processing apparatus 20 along with the corresponding electrode identification information.

In addition, when the user performs an operation of pushing in the outer cover 112 to push the outer shell 110 of the apparatus main body 11, the outer shell 110 is deformed, and while the user is pressing the outer shell 110, the electrode 121 disposed near the position being pressed is also pressed via the outer shell 110. Then, the CPU 1362 of the circuit section 13 detects the neighborhood of the electrode 121 being depressed, and generates proximity touch information related to the electrode 121. Then, the generated proximity touch information is delivered to the information processing apparatus 20 along with the electrode identification information regarding the electrode 121.

Further, when the user performs the operation of tapping the apparatus main body 11, immediately after the tapping, the outer shell 110 is deformed, and the electrode 121 disposed near the tapped position is pressed via the outer shell 110. Then, the CPU 1362 of the circuit section 13 detects the neighborhood of the electrode 121 being depressed, and generates proximity touch information related to the electrode 121. Then, the generated proximity touch information is delivered to the information processing apparatus 20 along with the electrode identification information regarding the electrode 121.

Subsequently, the outer shell 110 is deformed again by an elastic force and recovers to the original shape. At this time, the electrode 121 disposed near the tapped position is already in an unpressed state. Thus, since the neighborhood of the electrode 121 is not being depressed, the CPU 1362 of the circuit section 13 does not generate proximity touch information related to the electrode 121. Thus, the proximity touch information is not delivered to the information processing apparatus 20.

Upon receiving the proximity touch information from the interaction apparatus 1 along with the electrode identification information, the information processing apparatus 20 records the received electrode identification information and proximity touch information in the order of reception, and estimates the contents of the operation performed on the interaction apparatus 1 by the user, from the contents of the electrode identification information and proximity touch information or chronological changes in the information.

In an example of the present embodiment, the information processing apparatus 20 is assumed to include information indicating which position in the interaction apparatus 1 the electrode 121 identified by the electrode identification information is disposed in, the information being pre-recorded in the information processing apparatus 20 in association with the electrode identification information.

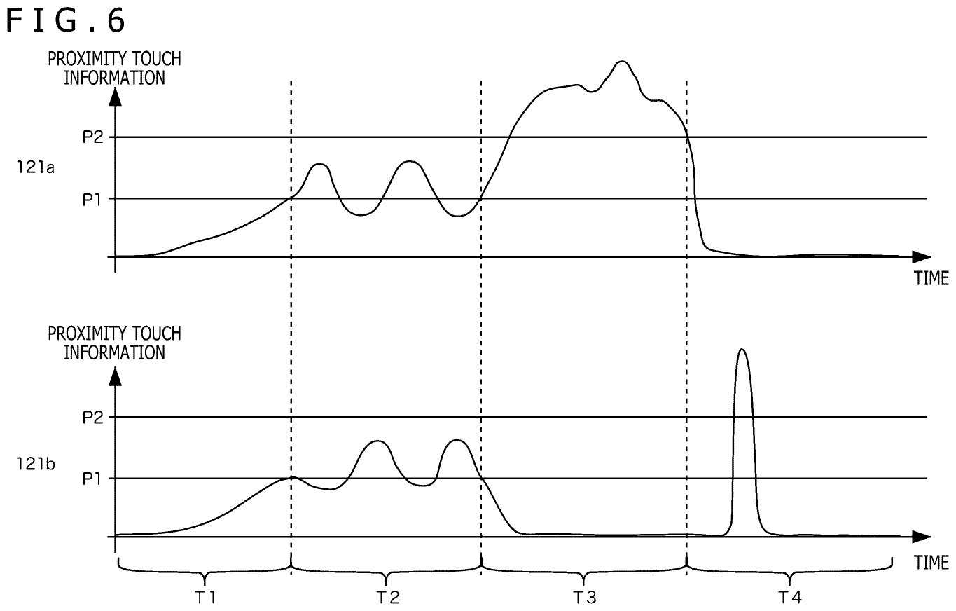

Further, for example, in a case where proximity touch information related to a certain electrode 121a and an electrode 121b adjacent to the electrode 121a is received as illustrated in FIG. 6, the information processing apparatus 20 estimates the operation performed by the user as follows.

Note that, here, in regard to the proximity touch information (which is assumed to be a one-dimensional value indicating the amount of change in capacitance) related to the electrodes 121a and 121b illustrated in FIG. 6, a plurality of thresholds P1 and P2 are assumed to be set in advance in order of increasing and further that, while the hand or finger of the user is not in proximity (while no proximity touch information has been received from the interaction apparatus 1), the value indicating the proximity touch information is assumed to be “0.”

When the proximity touch information related to a certain electrode 121 is not “0” but is below the threshold P1, the information processing apparatus 20 determines that the hand of the user is in proximity to the outer cover 112 near the electrode 121 but is not in touch with the outer cover 112.

In addition, when the proximity touch information related to a certain electrode 121 is above the threshold P1 but below the threshold P2, the information processing apparatus 20 determines that the hand of the user is in touch with the outer cover 112 near the electrode 121 but is not in touch with the outer shell 110.

Further, when the proximity touch information related to a certain electrode 121 is below the threshold P2, the information processing apparatus 20 determines that the user is pressing a portion of the outer shell 110 near the electrode 121 with a pressing force corresponding to the magnitude of the value of the proximity touch information.

It is assumed that the thresholds P1 and P2 as described above may be, for example, experimentally set in advance or dynamically set using proximity touch information obtained from the electrode during operation. Further, different thresholds P1 and P2 may be set for each electrode 121. In that case, for the proximity touch information related to each electrode 121, the information processing apparatus 20 is assumed to perform the above-described determination by using the thresholds P1 and P2 set for the corresponding electrode 121.

When the proximity touch information related to the electrodes 121a and 121b illustrated in FIG. 6 is recorded, the information processing apparatus 20 performing the determination as described above determines that, for a period T1, the hand of the user is approaching the electrodes 121a and 121b and that, for a period T2, the user is alternately touching the outer cover 112 at positions in proximity to the respective electrodes 121a and 121b. Thus, the information processing apparatus 20 estimates that the user is stroking positions near the portions where the electrodes 121a and 121b are disposed.

In addition, during a period T3, the proximity touch information related to the electrode 121a is above the threshold P2 for a relatively long period of time. The information processing apparatus 20 thus estimates that the user is pressing the neighborhood of the portion where the electrode 121a is disposed.

Further, during a period T4, the proximity touch information related to the electrode 121b is above the threshold P2 for only a relatively short period of time. The information processing apparatus 20 thus estimates that the user has tapped the neighborhood of the portion where the electrode 121b is disposed.

### Variation in Reference Value Due to Charging of Outer Cover

Further, in the interaction apparatus 1 of the present embodiment, the outer cover 112 is disposed on the surface of the outer cover 110, and thus, the outer cover 112 may be charged when the user comes into touch with the outer cover 112 or releases the hand from the outer cover 112, for example, affecting the detection result obtained by the capacitance sensor 12.

Thus, in an example of the present embodiment, as an external-force response processing operation already described, when predefined time (for example, approximately 5 to 10 seconds) has elapsed from the last reception, from the external-force sensor 137, of input of a signal indicating an external force exceeding a predetermined threshold, the CPU 1362 may determine that the outer cover 112 is in a state in which the user is not in touch with the outer cover 112, determine the detection result (for example, a difference d between a signal output by the DSP 1361 described above and a signal with a frequency f output by the oscillation circuit section 131) for each electrode 121 of the capacitance sensor 12 at that time has a value corresponding to a state in which the user is not in touch, and enable resetting of the output reference value (for example, re-setting the value d as an output reference value B).

Enabling resetting as used herein means that the CPU 1362 may immediately execute processing for resetting the output reference value to a value determined to correspond to a state in which the user is not in touch or may determine, when another predetermined condition is satisfied (for example, the information processing apparatus 20 has provided any indication or the like) after a resetting enabled state is established, that the detection result (for example, the difference d between the signal output by the DSP 1361 described above and the signal with the frequency f output by the oscillation circuit section 131) for each electrode 121 of the capacitance sensor 12 at that time has a value corresponding to the state in which the user is not in touch, and reset the output reference value (for example, re-set the value d as an output reference value B).

### Example of Utilization of Proximity Touch Information by Information Processing Apparatus

The information processing apparatus 20 may use the result of the above-described estimation to deliver the contents of the operation performed on the interaction apparatus 1 by the user, to another information processing apparatus 20, causing the other information processing apparatus 20 to control a stimulus provided to the hand or the like of the user who uses the other information processing apparatus 20.

In addition, the information processing apparatus 20 may use, for processing of a game, the contents of the operation performed on the interaction apparatus 1 by the user, to control parameters (information indicating a good-humoredness and the like) related to a virtual character.

Further, in response to the operation performed by the user tapping the interaction apparatus 1, for example, the information processing apparatus 20 may execute processing based on the determination that the virtual character has been attacked. At this time, the information processing apparatus 20 may control the type and strength of the attack, for example, according to the position on the interaction apparatus 1 tapped by the user and the strength of the tapping.

### Effects of Embodiment

According to the embodiment of the present invention, for example, even an interaction apparatus covered with fur or the like can be provided with a capacitance sensor along the inner surface of the outer shell disposed immediately below the fur. Thus, the proximity of the hand of the user to the degree that the user barely touches the fur can be detected, and the detection can be used for processing for estimating a touch with the fur, the strength of the touch, and the position of the touch. This enables an increase in the degree of freedom for the outer cover of the interaction apparatus.

### REFERENCE SIGNS LIST

1: Interaction apparatus
11: Apparatus main body
12: Capacitance sensor
13: Circuit section
20: Information processing apparatus
110: Outer shell
111: Framework
112: Fur
120: Substrate section
121: Electrode
122: Lead section
123: Wiring section
131: Oscillation circuit section
132: Analog multiplexer
133: Capacitance detection circuit section
134: A/D conversion section
135: BPF section
136: Control section
137: External-force sensor
1361: DSP
1362: CPU
1363: Storage section
1364: Communication section

1-5. (canceled)

6. An interaction apparatus comprising:
an outer shell including a material having elasticity; and
at least one capacitance sensor disposed near a surface of the outer shell, wherein the capacitance sensor includes a substrate section having elasticity, and at least one sensor electrode disposed on the substrate section.

7. The interaction apparatus of claim 6, wherein the capacitance sensor includes at least one opening and at least one cutout.

8. The interaction apparatus of claim 6, wherein the capacitance sensor includes at least one opening or at least one cutout.

9. The interaction apparatus according to claim 6, further comprising:
an external-force sensor and a processor that are disposed inside the outer shell, wherein in a case where a state in which the external-force sensor does not detect an external force continues for a predetermined period, the processor is enabled to reset an output reference value for the capacitance sensor.

10. The interaction apparatus of claim 6, wherein fabric is disposed on an outer portion of the surface of the outer shell.

11. The interaction apparatus of claim 6, comprising:
a processor, wherein the processor detects pressing on a basis of output from the capacitance sensor, and outputs proximity touch information indicating a result of the detection.
